(19) United States
(12) Patent Application Publication
(10) Pub. No.: US 2010/0229100 A1
(43) Pub. Date: Sep. 9, 2010

(54) Methods and Systems for Storing and Accessing Application History

(75) Inventors: Kristen Miller, Olathe, KS (US); Michael T. Lundy, Olathe, KS (US); Jesse M. Kates, Kansas City, MO (US); R. Brian Landers, Leawood, KS (US)

Correspondence Address: SPRINT, 6391 SPRINT PARKWAY, KSOPHT0101-Z2100, OVERLAND PARK, KS, 66251-2100, US

(73) Assignee: SPRINT SPECTRUM L.P., Overland Park, KS (US)

(21) Appl. No.: 12/396,895

(22) Filed: Mar. 3, 2009

(51) Int. Cl. G06F 3/00

(52) U.S. Cl. 715/745; 719/328

(57) ABSTRACT

In a communication device, multiple instances of different applications may execute. Advantageously, at least one instance of an application records and stores a browsing history of data items accessed during its execution. This stored browsing history may be made available to later instances of applications. Furthermore, one or more such stored histories may be accessed via a global back or a global forward command, allowing the histories to be browsed according to the order in which they were recorded.

### BACKGROUND

Wireless communication devices (WCDs), such as mobile phones, have grown more powerful and feature-rich. WCDs now support many different productivity, information, and entertainment applications. For instance, some popular mobile phone platforms support email, calendar, contact management, web browsing, navigation, location mapping, and gaming applications.

These WCDs run a variety of mobile operating systems, such as Blackberry OS, iPhone OS, PALM OS®, WINDOWS MOBILE®, SYMBIAN OS®, and ANDROID®, just to name a few. Mobile phone manufacturers may utilize other proprietary or customized mobile operating systems, such as variations of Linux.

Some of these mobile operating systems are traditional multitasking operating systems, which allow more than one application to execute at the same time, while others are single-tasking operating systems, which allow only one application to execute at a time. Since WCDs typically have limited screen sizes, usually a WCD will only display one application at a time, regardless of the type of operating system. Thus, on a WCD, a multitasking operating system may allow only one application to execute in the foreground and be displayed on the WCD's screen. Any other executing applications would execute in the background, and would not be displayed on the WCD's screen. A single-tasking operating system preferably does not support executing applications in the background and instead only supports the executing application to be displayed in the foreground, until it is terminated.

Furthermore, some mobile operating systems may support a limited multitasking mode, in which some applications are permitted to run in the background while others are not. Such a mode may be used, for instance, to only allow applications that are certified (or approved, etc.) by the WCD manufacturer, the mobile operating system manufacturer, and/or another party, to run in the background. The advantage of doing so is to prevent non-certified (or non-approved, etc.) third-party applications from silently exploiting WCD resources when these applications are not being actively operated by a user.

For instance, a third-party application may intentionally, or due to programming errors, make use of excessive processor, memory, or network resources while running in the background. Such an occurrence may, for example, drain the WCD's battery, and/or slow down other applications executing on the WCD, including the application executing in the foreground.

This would likely have a deleterious impact on the user of the WCD, potentially causing the user to become frustrated with the manufacturer of the WCD and/or with the manufacturer of the mobile operating system rather than the third-party application.

Thus, it can be appreciated that even mobile operating systems that support multitasking may not allow all applications to execute in the background. Accordingly, information used during one instance of an application may not be available when a user later invokes another instance of that application.

### OVERVIEW

When a user of a mobile operating system accesses a series of data items across multiple instances of one or more applications, an accurate history of these accesses may not be recorded. This is due to either the applications failing to store the order in which the data items were accessed in each instance, the mobile operating system failing to store the order in which each instance of an application was executed, or both. Therefore, the user will not be able to easily retrieve an accurate history of previously accessed data items.

Methods and systems for storing at least a portion of the history of one or more applications, so that the history can be accessed at a later point in time, are presented. This access is preferably facilitated by global back and/or global forward commands that enable seamless browsing across multiple histories, where each history is associated with an instance of an application.

Preferably a first instance of an application stores some aspect of its history in a memory. The exact data stored may vary based on the application. For instance, a web browsing application executing on a WCD may store a set of URLs representing an ordered list of web sites that were visited during the execution of the first instance of the application. Similarly, an email application may store a set of recently accessed email messages, and a location mapping application may store a set of recently accessed coordinates. Clearly, many other examples are possible as well.

Once stored, this history is preferably available to later instances of the application, and/or later instances of another application via the global back and/or global forward commands. Assume, for example, after the web browsing application terminates, an email application is executed. The email application also records and stores its history. During the execution of the email application, if the WCD receives a global back command, it may direct the email application to browse backwards in its own history, or to access the web browsing application's stored history. In accessing the web browsing application's stored history, the WCD may terminate the email application, launch a new instance of the web browsing application, and load the web browsing application's stored history into the web browsing application. In this way, users may rapidly access the stored history of previously executed applications, and are spared the inconvenience of having to remember and re-enter URLs, or other data, into their WCDs.

The history associated with an instance of an application may be stored according to the chronological order of when each item in the history was accessed. Additionally, the history may be stored with an indication of the application to which it belongs. One method of providing such a common method of storing (and then later accessing) these histories is via a well-known application programming interfaces (API) built into the WCD's mobile operating system, via application layer library routines, via plugin software modules, or through other means.

Regardless of exactly how this mechanism is implemented, one embodiment may involve a first instance of a first application recording a first browsing history. The first browsing history may contain a first ordered list of data items used by the first instance of the first application. During execution of the first instance of the first application, the WCD may receive a first launch command to launch a second application. Responsive to receiving this command, the WCD may (1) instruct the first application to store the first browsing history, (2) terminate the first instance of the first application, and (3) launch the second application.

The second application may record a second browsing history of the second application. During execution of the second application, the WCD may receive a global back command, directing it to return to the first application. Responsive to receiving the global back command the WCD may (1) launch a second instance of the first application, and (2) load the first browsing history into the second instance of the first application such that the most recently used data item in the first browsing history is displayed in the second instance of the first application.

In this way, a global back command can launch a later instance of an application to access and use the browsing history of an earlier instance of the application, even as the later instance of the application records its own browsing history. Furthermore, a later instance of a different application may be able to use the browsing history of the earlier instance of the application. For example, an email application might make use of a URL from a web browsing application's browsing history so that the URL can be provided in an email message.

Another embodiment may involve, during a first execution of a first application, the storing of a first browsing history of data items used by the first application. This first browsing history may comprise a last entry containing a most recently used data item of the first browsing history. Then, during execution of a second application, a second browsing history of data items used by the second application may also be stored. The second browsing history may comprise a first entry containing a least recently used data item. Also during execution of the second application, the WCD may receive a global back command and responsively terminate the second application, launch a second execution of the first application, and display the last entry of the first browsing history in the first application.

Yet another embodiment may involve, during execution of a first application on a WCD, the recording of a first browsing history of the first application, where the first browsing history contains a first ordered list of data items used by the first instance of the first application. Furthermore, during execution of a second application on the WCD, a second browsing history of the second application may also be recorded, where the second browsing history contains a second ordered list of data items used by the second application. The first and second browsing histories may be represented in a combined fashion as an inter-application browsing history.

Then, during execution of the second application, the WCD may receive a command to move forward or backward in the inter-application browsing history. This command may be received from the user interface, or via some other means. If the currently displayed data item from the second ordered list of data items is at the end of that list, then the WCD may perform the following steps: (1) storing the second browsing history associated with an identifier of the second application, (2) terminating the second application, (3) launching the first application, and (4) loading the first browsing history into the first application. However, if the currently displayed data item is not at the end of the second ordered list of data items, then a different data item from the second ordered list of data items may be displayed in the second application. This different data item may be adjacent to the currently displayed data item in the second ordered list of data items.

In this embodiment, a command, such as a global back or a global forward command, may navigate within the second browsing history of the executing second application. If, after one or more invocations of this command, either end of the second browsing history is reached, the command may then trigger the invocation of a second instance of the first application, and continue browsing from an end of the first browsing history.

These and other aspects and advantages will become apparent to those of ordinary skill in the art by reading the following detailed description, with reference where appropriate to the accompanying drawings. Further, it should be understood that the foregoing overview is merely exemplary and is not intended to limit the scope of the invention as claimed.

### BRIEF DESCRIPTION OF THE DRAWINGS

FIG. 1 depicts a block diagram of a WCD in accordance with an exemplary embodiment;

FIGS. 2, 3, 4A, 4B, 4C, and 4D each depict a series of applications operating on a WCD in accordance with exemplary embodiments;

FIG. 5 depicts several exemplary types of application browsing histories in accordance with exemplary embodiments;

FIGS. 6A, 6B, 6C, and 6D depict methods of storing and accessing application browsing histories in accordance with exemplary embodiments;

FIGS. 7A, 7B, and 7C depict further methods of storing and accessing application browsing histories in accordance with exemplary embodiments; and

FIG. 8 depicts another method of storing and accessing application browsing histories in accordance with an exemplary embodiment.

### DESCRIPTION

Disclosed herein are methods and systems for storing and accessing application history. For purposes of illustration, the discussion below is directed to storing and accessing application history on a WCD. However, it should be understood that any teachings herein may apply to other types of communication devices, such as wireline communication devices, and that this illustration should not be construed as limiting the scope of the invention.

### I. Exemplary Wireless Communication Device

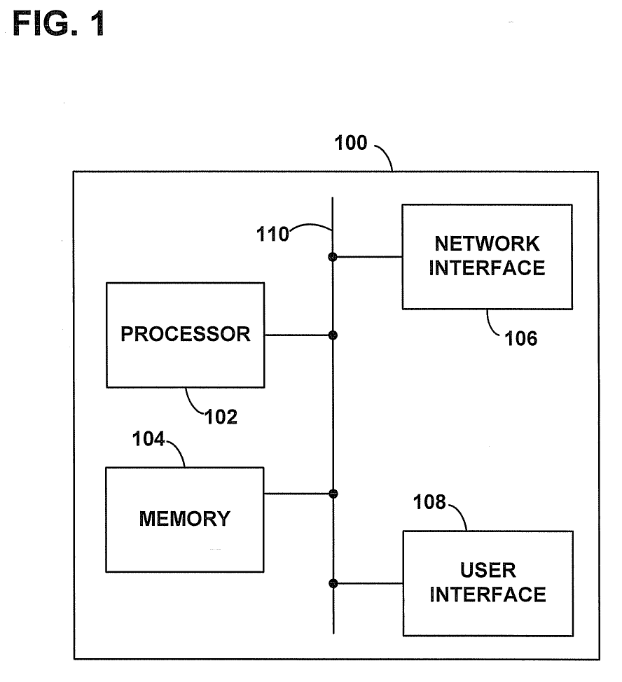

FIG. 1 is a simplified block diagram depicting an example WCD 100 that may be configured to operate in accordance with preferred embodiments. WCD 100 may be a cell phone, mobile phone, mobile data device, sensor device, laptop computer, personal computer or some other type of device that communicates with other communication devices via point to point links or via a network.

FIG. 1 also depicts some of the functional components that would likely be found in a WCD arranged to operate in accordance with the embodiments described herein. Example WCD 100 preferably includes a processor 102, a memory 104, a network interface 106, and an input/output function 108, all of which may be coupled by a system bus 110 or a similar mechanism.

Processor 102 preferably includes one or more CPUs, such as one or more general purpose processors and/or one or more dedicated processors (e.g., application specific integrated circuits (ASICs) or digital signal processors (DSPs), etc.) Memory 104, in turn, may comprise volatile and/or non-volatile memory and can be integrated in whole or in part with processor 102. Memory 104 preferably holds program instructions executable by processor 102, and data that is manipulated by these instructions, to carry out various logic functions described herein. Alternatively, the logic functions can be defined by hardware, firmware, and/or any combination of hardware, firmware and software.

Network interface 106 may take the form of a wireless connection, perhaps operating according to IEEE 802.11, BLUETOOTH®, CDMA, WIMAX®, IDEN®, UMTS®, LTE®, or any other protocol or protocols used to communicate with other communication devices or a network. Other forms of physical layer connections and other types of standard or proprietary communication protocols may be used over network interface 106. Furthermore, network interface 106 may comprise multiple physical or logical network interfaces, each capable of operating according to the same or different protocols.

Input/output function 108 facilitates user interaction with example WCD 100. Input/output function 108 may comprise multiple types of input devices, such as a keypad, a keyboard, a microphone, a mouse, a trackball, a dial, a touch screen, and so on. Similarly, input/output function 108 may comprise multiple types of output devices, such as a display screen, a speaker, a monitor, a printer, or one or more light emitting diodes (LEDs). Additionally or alternatively, example WCD 100 may support remote access from another device, via network interface 106 or via another interface (not shown), such an RS-232 port.

Preferably, input/output function 108 is capable of presenting the output of an application executing on WCD 100 to a user. Furthermore, input/output function 108 is also preferably capable of receiving one or more commands from a user to switch between applications, access a browsing history, or navigate a browsing history. It should be understood that the exact input and output functions supported by WCD 100 can differ from the types of input and output functions listed above while still allowing WCD 100 to perform the embodiments described herein.

Memory 104 preferably contains data as well as stored program logic, executable by processor 102, and capable of manipulating the data. By way of example, the data in memory 104 will preferably contain stored browsing histories of one or more instances of one or more applications.

Memory 104 may also contain stored program logic that is executable by processor 102 to launch a first instance of a first application, record a first browsing history of a first application, and store the first browsing history associated with the first application. Memory 104 may further contain stored program logic that is executable by processor 102 to launch a first instance of a second application, record a second browsing history of the second application, and store the second browsing history associated with the second application. Preferably, execution of the first instance of the second application was initiated after execution of the first instance of the first application was initiated.

Additionally, memory 104 may also contain stored program logic that is executable by processor 102 to receive input from the user interface during execution of the first instance of the second application, and responsively (1) execute a second instance of the first application, and (2) load the first browsing history into the first application for use by the first application. More generally, memory 104 may also contain stored program logic that is executable by processor 102 to carry out any of the functions described herein.

In addition to the components and functions discussed above, WCD 100 may support additional components and functions, including components and functions used to perform any of the methods described herein.

### II. Storage of Application History

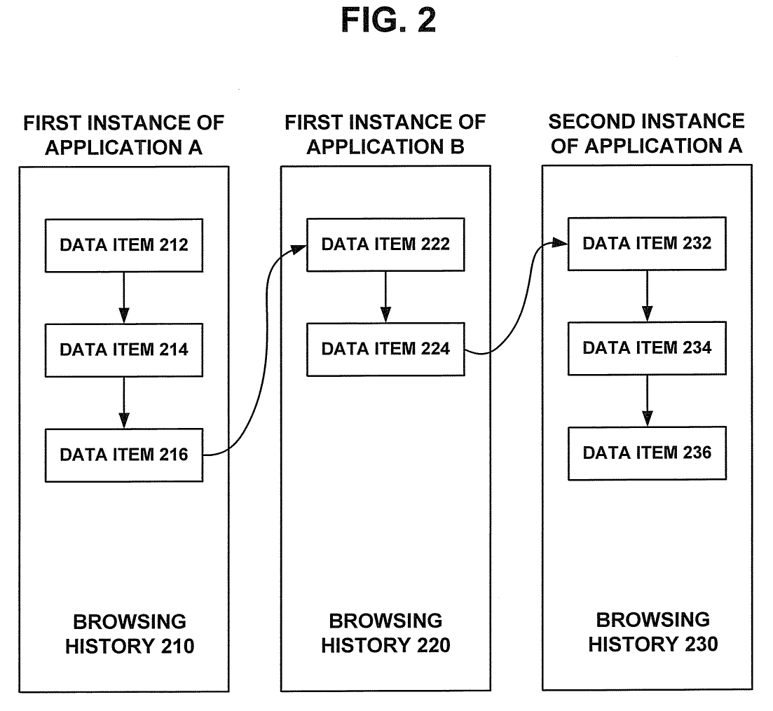

FIG. 2 represents the execution of instances of exemplary applications on a WCD according to user interaction with the WCD. (While the WCD may be manipulated by a user, it is within the scope of the embodiments herein for the application to operate under the control of a non-human entity, such as another application.) A first instance of an exemplary application A executes, and a user browses, accesses and/or displays data item 212, then data item 214, then data item 216. A record of this browsing history, preferably including the order in which the data items were accessed, may be stored in browsing history 210.

After the first instance of application A is terminated, application B may execute. During the execution of application B, a user browses, accesses and/or displays data item 222, then data item 224. A record of this browsing history, preferably including the order in which the data items were accessed, may be stored in browsing history 220.

After application B is terminated, a second instance of application A executes, and a user browses, accesses and/or displays data item 232, then data item 234, then data item 236. A record of this browsing history, preferably including the order in which the data items were accessed, may be stored in browsing history 230. However, in this case, browsing history 230 may be different from browsing history 210.

A combined representation of browsing history 210, browsing history 220, and browsing history 230, including all data items in the order they were accessed, can be formed from the stored information. This combined representation effectively is an inter-application history of the data items accessed. Additionally, a global back function and a global forward function are defined so that this inter-application history can be navigated.

Upon receipt of a global back command, the global back function moves backwards through this history, while upon reception of a global forward command, the global forward function moves forward through this history. The global back function may operate in two ways. First, it may move backwards linearly through the inter-application history. For example, from data item 224, successive invocations of the global back command would access data item 222, then data item 216, and so on. When data item 216 is accessed, a new instance of application A may be launched in order to properly display data item 216.

Alternatively, the global back function may move between instances of the applications. For example, from a data item in browsing history 230, successive invocations of the global back command could access a data item in browsing history 220, then a data item in browsing history 210. When each of these data items is accessed, a new instance of the application that stored the data item in a browsing history may be launched so that the data items are properly displayed. Within a given browsing history, such as browsing history 210, browsing history 220, or browsing history 230, the user may be able to navigate between data items of the given browsing history by using mechanisms inherent to the application.

Analogously, the global forward function may also operate in two ways. First, it may move forward linearly through the inter-application history. For example, from data item 222, successive invocations of the global forward command would access data item 224, then data item 232, and so on. When data item 232 is accessed, a new instance of application A may be launched in order to properly display data item 232. The global forward function may also move between instances of the applications. For example, from a data item in browsing history 210, successive invocations of the global forward command could access a data item in browsing history 220, then a data item in browsing history 230.

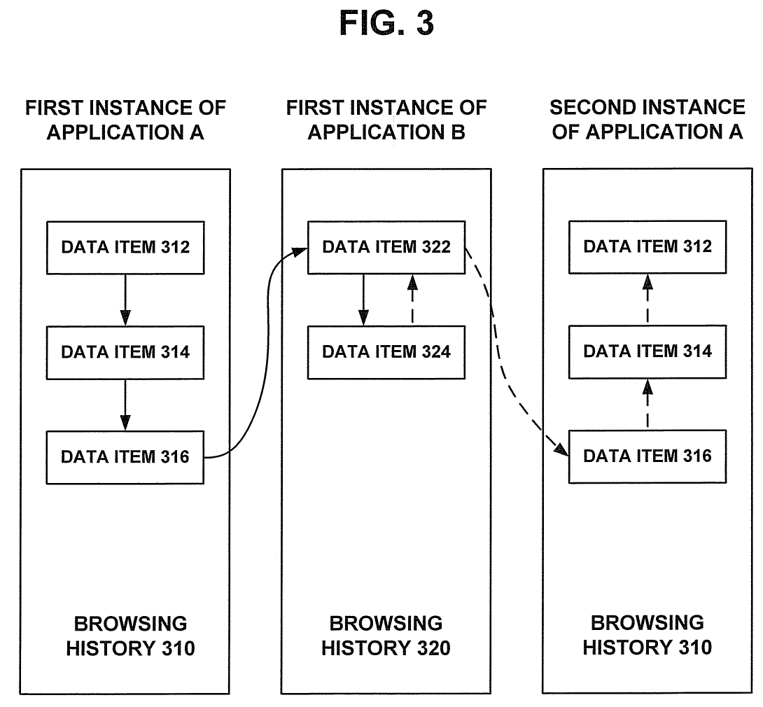

Accordingly, FIG. 3 depicts a means to provide access, while executing a later instance of an application, to a browsing history from an earlier instance of the application. For example, in FIG. 3, a first instance of application A executes, and a user browses, accesses and/or displays data item 312, then data item 314, then data item 316. A record of this browsing history, preferably including the order in which the data items were accessed, may be stored in browsing history 310.

After the first instance of application A is terminated, application B may execute. During the execution of application B, a user browses, accesses and/or displays data item 322, then data item 324. A record of this browsing history, preferably including the order in which the data items were accessed, may be stored in browsing history 320.

While application B is displaying data item 324, a global back command is received. (Throughout the figures, movement between data items due to the use of a global back or a global forward command is depicted using a dotted line.) This command may be received from or via a user interface, a network interface, or some other means. Responsive to receiving the global back command, the previously-displayed data item, data item 322, may be displayed by application B. If another global back command is received while data item 322 is displayed, then a second instance of application A may be launched and the most recently displayed data item from stored browsing history 310, data item 316, may be displayed. Alternatively, the first global back command may trigger the launching of the second instance of application A and the loading of data item 316.

Regardless of how or when the second instance of application A is launched, upon receiving a global back command, the following steps may be performed: (1) application B stores browsing history 320 in memory and associates browsing history 320 with an identifier of application B, (2) application B is terminated, (3) a second instance of application A is launched, and (4) browsing history 310 is loaded into the second instance of application A, such that a most recently used data item in the browsing history 310 is displayed in the second instance of the application A. In this case, data item 316 is the most recently accessed data item in browsing history 310, so it is preferably displayed by the second instance of application A.

A further global back command received while the second instance of application A displays data item 316, may result in the displaying of the next-most-recent data item in browsing history 310, data item 314. Accordingly, another global back command received while data item 314 is displayed may result in the displaying of data item 312.

This functionality, as depicted in FIG. 3 and described above, involves cross-application navigation through multiple browsing histories in a single command. The command may be invoked via a back button, not unlike the back button of a web browser, or through a different means. For instance, the command may be associated with a dedicated key on a keypad or keyboard of a WCD. Additionally, a similar global forward command may be available, involving cross-application navigation through multiple browsing histories in a forward direction.

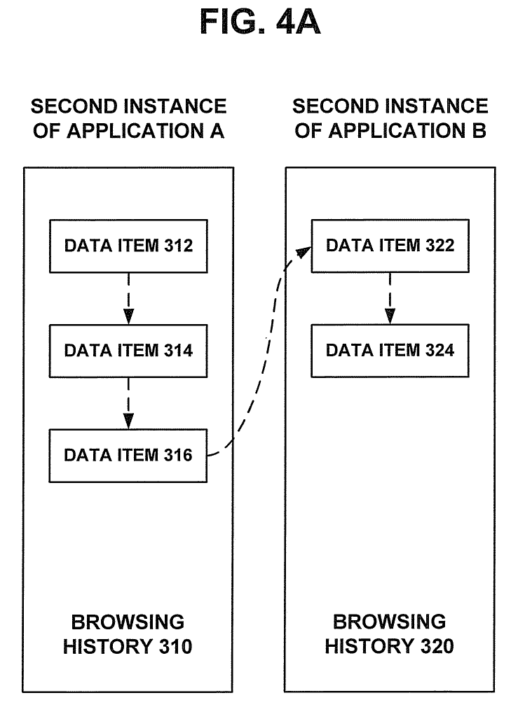

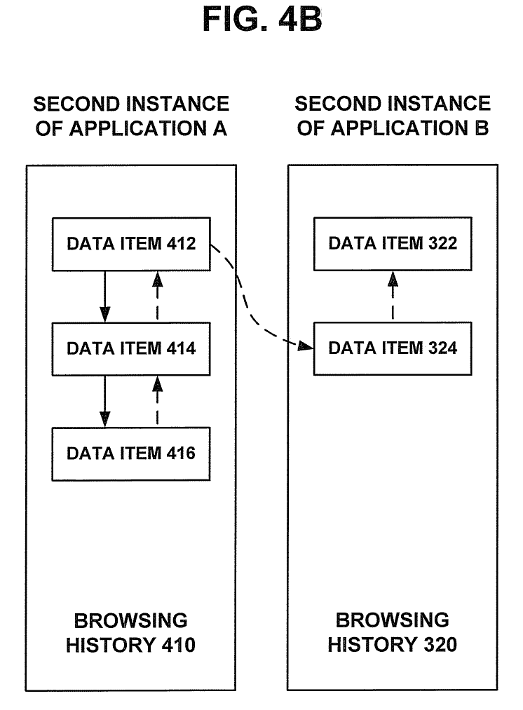

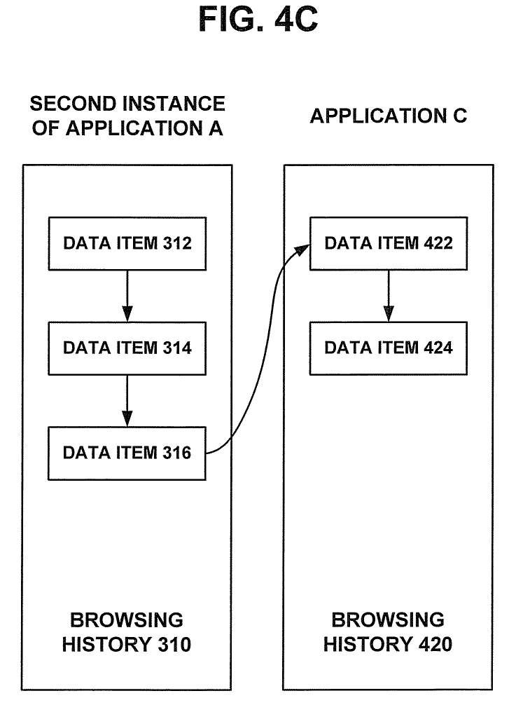

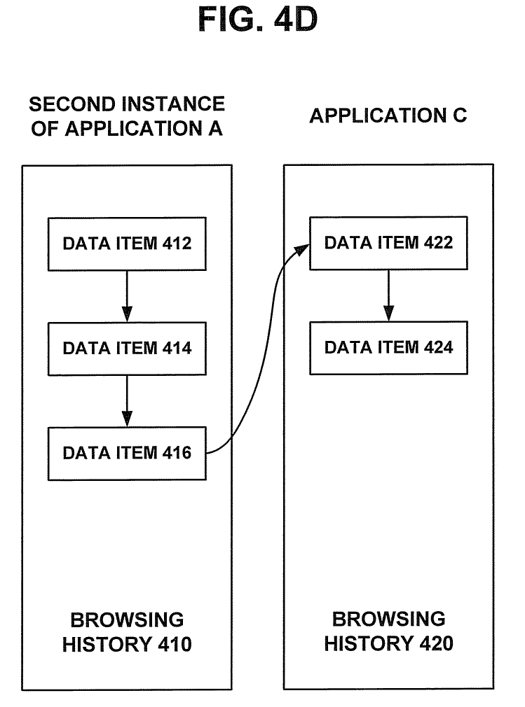

An example of the operation of such a global forward command is shown in FIG. 4A. Picking up where the depiction of browsing history access leaves off in FIG. 3, data item 312 of browsing history 310 is displayed in the second instance of application A. The global forward command is invoked twice, advancing to data item 314, then to data item 316. The global forward command is then invoked once more. Due to data item 316 being at an end of browsing history 310, the second instance application A is terminated in response to this invocation. Then, a second instance of application B is launched, and browsing history 320 is loaded into the second instance of application B. The least recently used data item in the browsing history 320, data item 322, may then be displayed in the second instance application A. A subsequent invocation of the global forward command may result in data item 324 being displayed.

While a previously recorded and stored browsing history, such as browsing history 310 or browsing history 320 is being accessed by a later instance of an application, the application may still record a new browsing history. For instance, when a previously saved browsing history is loaded into a second instance of a web browser, the user may access the data items stored in the previously saved browsing history. However, when the user navigates to one or more URLs not in the previously saved browsing history, a new browsing history may be recorded. Nonetheless, from this new browsing history, a global back or global forward command can still be used to access stored browsing histories from other instances of applications.

FIG. 4B depicts an embodiment also picking up where the depiction of browsing history access leaves off in FIG. 3. In this embodiment, the second instance of application A is launched, and a new browsing history, browsing history 410, is created. Browsing history 410 records the access of data item 412, then data item 414, then data item 416.

During the display of data item 416, a global back command is received, and data item 414 is displayed. During the subsequent display of data item 414, a second global back command is received, and data item 412 is displayed. During the display of data item 412, a third global back command is received, and responsively, a second instance of application B is launched and browsing history 320 is loaded into application B.

Alternatively, the first received global back command may trigger the launch of a second instance of application B and the loading of browsing history 320 into application B. Regardless of how the launch of the second instance of application B is achieved, the invocation of a global back command may trigger the second instance of application A to be terminated, a second instance of application B to be launched, and browsing history 320 to be loaded into the second instance of application B. The most recently used data item in the browsing history 320, data item 324, may be displayed in the second instance of application B. Once the second instance of application B is displaying data item 324, a further global back command may trigger the display of the next-most recently used data item, data item 322.

FIG. 4C depicts another embodiment, also picking up where the depiction of browsing history access leaves off in FIG. 3. In this embodiment, following the access of data item 312, data item 314, and data item 316, a new application, application C, is launched.

During execution of application C, browsing history 420 records and stores accessed data item 422 and data item 424. During the execution of application C, invocation of a global back command may result in the displaying of previously accessed data items in browsing history 420 and/or browsing history 310.

FIG. 4D depicts yet another embodiment, once again picking up where the depiction of browsing history access leaves off in FIG. 3. In this embodiment, the new browsing history 410, containing data item 412, data item 414, and data item 416 has been loaded into a second instance of application A. Following the display of data item 416, a new application, application C, is launched.

During execution of application C, browsing history 420 records and stores accessed data item 422 and data item 424. During the execution of application C, invocation of a global back command may result in the displaying of previously accessed data items in browsing history 420 and/or browsing history 410.

### III. Arrangements of Application History

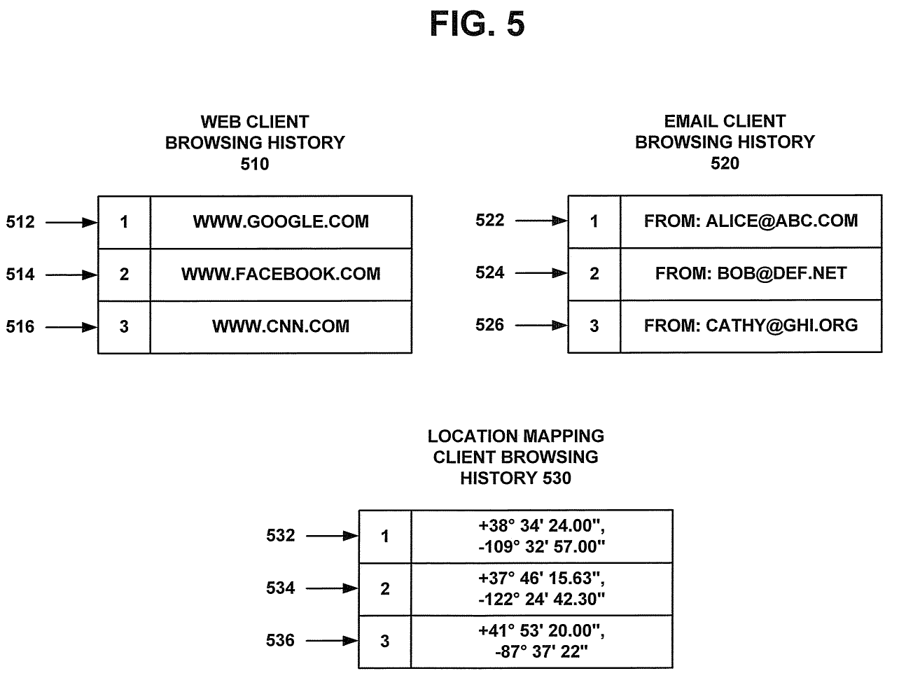

As stated above, different types of applications may record and store different types of data items in their respective browsing histories. FIG. 5 depicts three exemplary browsing histories, each associated with an exemplary application. While each of the browsing histories depicted in FIG. 5 contain three data items, a browsing history may contain as little as one data item, or may contain an arbitrarily large number of data items.

Web client browsing history 510 contains a set of three URLs stored in data item 512, data item 514, and data item 516, respectively. The URLs are ordered in web client browsing history 510 from the least recently accessed (data item 512) to the most recently accessed (data item 516). The data items are also numbered, from 1 to 3, in the order that they were accessed. However, this numbering is optional and merely illustrative.

The URLs referred to in web client browsing history 510 represent the addresses of three web sites that were accessed by a web browsing application. These URLs may be formatted according to Internet Engineering Task Force (IETF) Request For Comments (RFC) 1738, which is hereby incorporated herein in its entirety, or according to other formatting schemes. Thus, for example, the URLs referred to in web client browsing history 510 may also contain protocol directives, such as http://, ftp://, and so on, as well as more elaborate syntax. Alternatively, these data items may take on various other forms, such as reference numbers that are associated with URLs or web sites, or some other type of pointer to URLs or web sites.

Along with each URL, web client browsing history 510 may also contain a cached copy of the web page to which the URL refers. Thus, for instance, data item 514 may contain a copy of a most recently loaded www.facebook.com web page. This allows a web client to rapidly display the web page associated with each URL, so that the user (or some other entity) can quickly browse back and forth between data items while accessing web client browsing history 510.

Email client browsing history 520 contains a set of three email messages stored in data item 522, data item 524, and data item 526, respectively. The email messages are ordered in email client browsing history 520 from the least recently accessed (data item 522) to the most recently accessed (data item 526). As in web client browsing history 510, the data items are numbered, from 1 to 3, in the order that they were accessed. However, this numbering is optional and merely illustrative.

Each of data item 522, data item 524, and data item 526 may contain an entire email message, including an email header and an associated email body. Alternatively, these data items may contain only an email header or an email body. If such a data item contains an email body, this email body may be complete or partial. A complete email body, for example, may contain text and one or more attachments, while a partial email body may contain just text.

In another alternative, each of data item 522, data item 524, and data item 526 may instead contain a shortened reference to an email message. As an example, these data items may contain just an indication of the sender or a recipient of an email message, a timestamp associated with the email message or both. For instance, data item 522 contains a “From alice@abc.com” reference, indicating the sender of the email message. However, these data items may take on various alternative forms, such as reference numbers that are associated with email messages, or some other type of pointer to email messages.

Using such a shortened reference allows the email client to rapidly display a reference to the email message associated with each data item, so that the user (or some other entity) can quickly browse back and forth between data items while accessing email client browsing history 520. An email client may facilitate display of the email message associated with a reference by, for instance, letting the user click on or hover over the reference. In response, the email client may load the email message from local memory or a remote server, and then display it.

Location mapping client browsing history 530 contains a set of three location references stored in data item 532, data item 534, and data item 536, respectively. The location references are ordered in location mapping client browsing history 530 from the least recently accessed (data item 532) to the most recently accessed (data item 536). As in web client browsing history 510 and email client browsing history 520, the data items are numbered, from 1 to 3, in the order that they were accessed. Once again, this numbering is optional and merely illustrative.

Each of data item 532, data item 534, and data item 536 may contain a location reference that includes coordinates of a location. The coordinates may take the form of longitude and latitude, GPS coordinates, a URL, or any other form of identifying a physical or virtual position. (A virtual position can take on many meanings, including but not limited to a location in a virtual world or a location on a network.) For example, data item 532, data item 534, and data item 536 each contain longitude and latitude coordinates. However the physical locations to which these coordinates map can be referenced by different coordinate systems.

In addition to the location reference in these data items, the data items may also include other data. This data may provide additional information about the physical or virtual position associated with the location reference. For instance, this information may include a street address, name of a street or intersection, or the name of a city. Furthermore, this information may include a map or a link to a map that graphically depicts some aspect of the physical or virtual position. Alternatively, these data items may take on other forms, such as reference numbers that are associated with coordinates, or some other type of pointer to coordinates.

It should be understood that the example application browsing histories shown in FIG. 5 are not a comprehensive representation of all possible types of application histories. Accordingly, different types of application histories not shown here may be used with the methods and systems described herein.

For instance, application browsing histories may include data items that could be used to reconstruct a particular application context. This could take the form of an application context, such as the data items discussed above, or a user interface context. A user interface context may include data items representing a particular application input and/or output state. With respect to a location mapping client browsing history, a user interface context may include representation of a map or portion of a map and the arrangement of the map with respect to particular coordinates.

Moreover, storage of and access to these browsing histories may be accomplished via a common application programming interface (API) that is available to multiple applications that execute on a given WCD. This API may be implemented via the WCD's operating system, programming libraries, plugin software modules, or through other techniques. Such an API may facilitate the creation and deletion of multiple browsing histories, as well as the ability to write to, edit, and read from a browsing history.

Using this API, or an alternate means, multiple application browsing histories may be stored. These browsing histories may be stored in operating system (e.g., kernel) memory, or in application memory. Furthermore, these browsing histories may be stored so that the order in which instances of the applications were executed, as well as the order data items were accessed in each instance of the application, may be preserved.

In addition to these functions, the API may limit the total number of browsing histories that it stores, so that memory utilization is bounded. However, the API may store these browsing histories across one or more reboots or power cycles of the WCD, so that stored browsing histories are available even after a user resets or power cycles his or her WCD.

### IV. Exemplary Methods of Storing and Accessing Application History

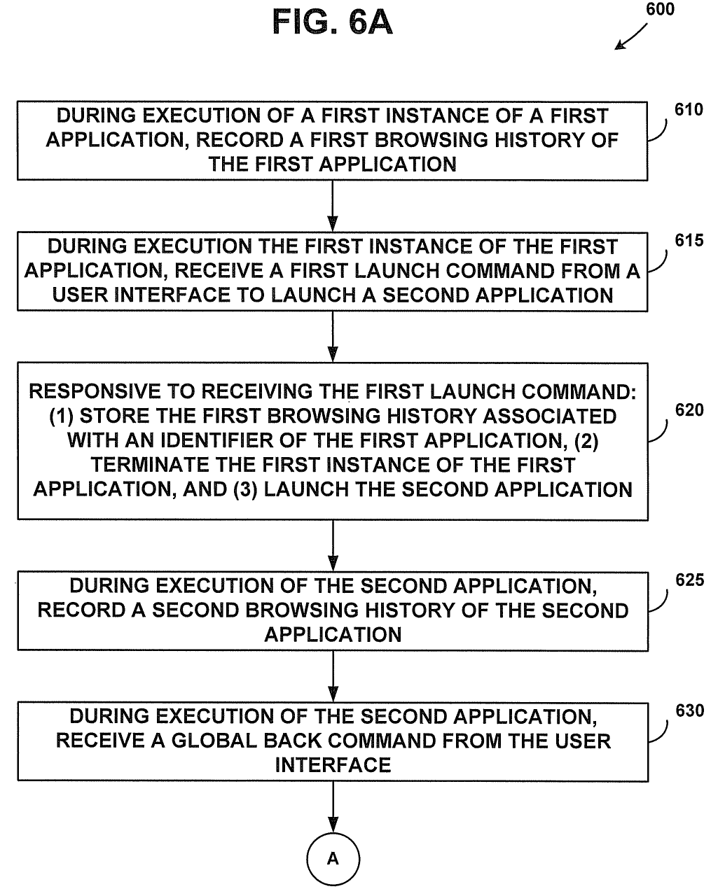

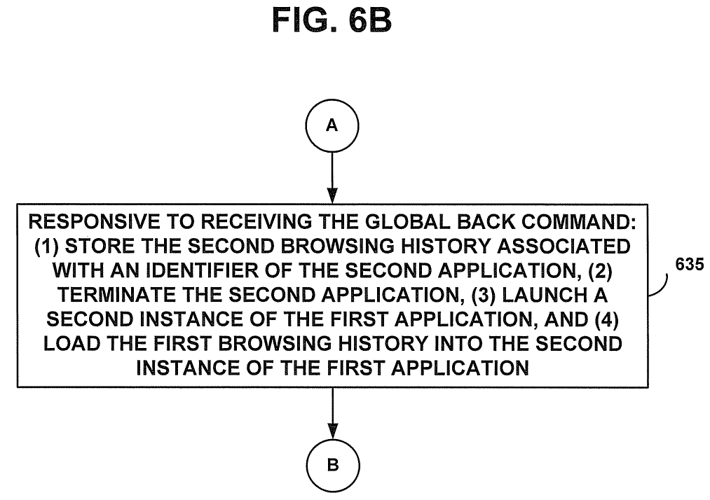

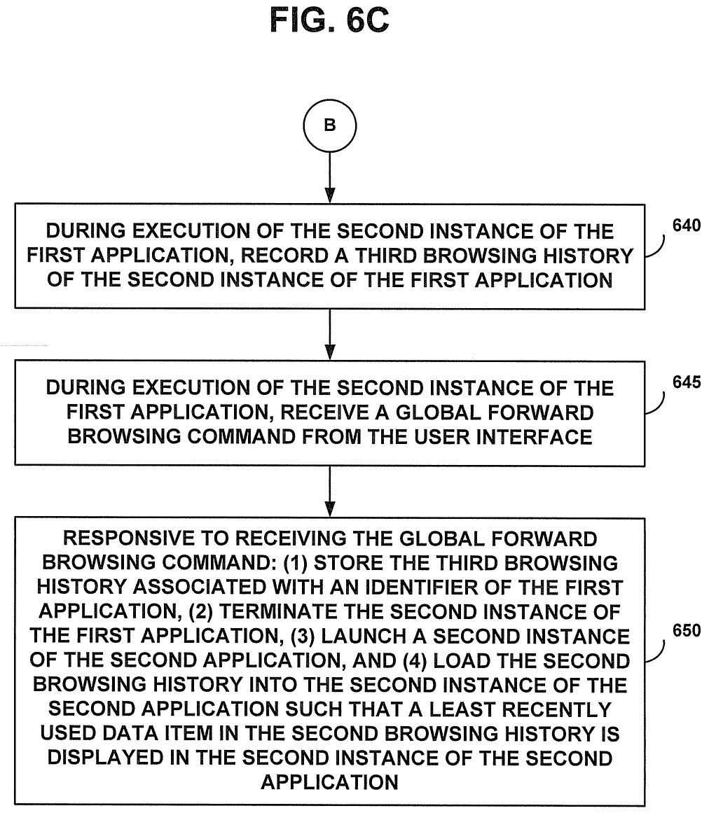

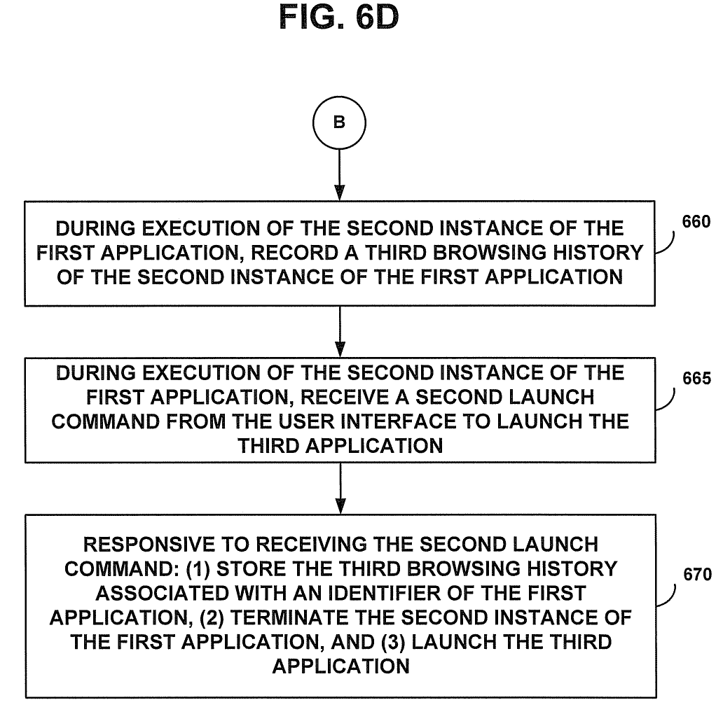

FIG. 6A depicts part of a method 600 for storing and accessing application history. At step 610, during execution of a first instance of a first application, a first browsing history of the first application is recorded. Preferably the first browsing history contains a first ordered list of data items used by the first instance of the first application. At step 615, also during execution the first instance of the first application, a first launch command is received from the user interface. The first launch command preferably seeks to launch a second application.

In response to receiving the first launch command, at step 620, (1) the first browsing history is stored associated with an identifier of the first application, (2) the first instance of the first application, is terminated, and (3) the second application is launched. Then, at step 625, during execution of the second application, a second browsing history of the second application is recorded. Similar to the first browsing history, the second browsing history contains a second ordered list of data items used by the second application.

At step 630, during execution of the second application, a global back command is received from the user interface. Turning to FIG. 6B, responsive to receiving the global back command, at step 635, (1) the second browsing history is stored associated with an identifier of the second application, (2) the second application is terminated, (3) a second instance of the first application is launched, and (4) the first browsing history is loaded into the second instance of the first application. Preferably, a most recently used data item in the first browsing history is displayed in the second instance of the first application.

Once the second instance of the first application is executing, a user, or some other entity, may seek to either return to the second application, or launch a third application. FIG. 6C depicts a method, continuing from the method depicted in FIG. 6B, for returning to the second application. At step 640, a third browsing history of the second instance of the first application is recorded during execution of the second instance of the first application. Preferably, the third browsing history contains an ordered list of data items used by the second instance of the first application. The third browsing history may be different from the first browsing history.

At step 645, during execution of the second instance of the first application, a global forward browsing command is received from the user interface. Responsive to receiving the global forward browsing command, at step 650, (1) the third browsing history is stored associated with an identifier of the first application, (2) the second instance of the first application is terminated, (3) a second instance of the second application is launched, and (4) the second browsing history is loaded into the second instance of the second application such that a least recently used data item in the second browsing history is displayed in the second instance of the second application.

FIG. 6D depicts another method, also continuing from the method depicted in FIG. 6B, for launching a third application. At step 660, during execution of the second instance of the first application, a third browsing history of the second instance of the first application is recorded. Preferably, the third browsing history contains an ordered list of data items used by the second instance of the first application. The third browsing history may different from the first browsing history.

At step 665, during execution of the second instance of the first application, a second launch command recording from the user interface. Responsive to receiving the second launch command, at step 670, (1) the third browsing history is stored associated with an identifier of the first application, (2) terminating the second instance of the first application, and (3) launching the third application.

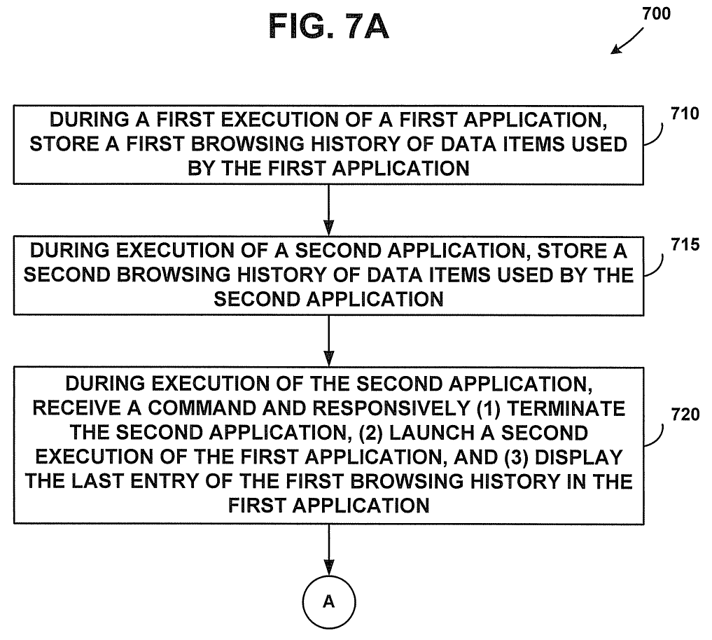

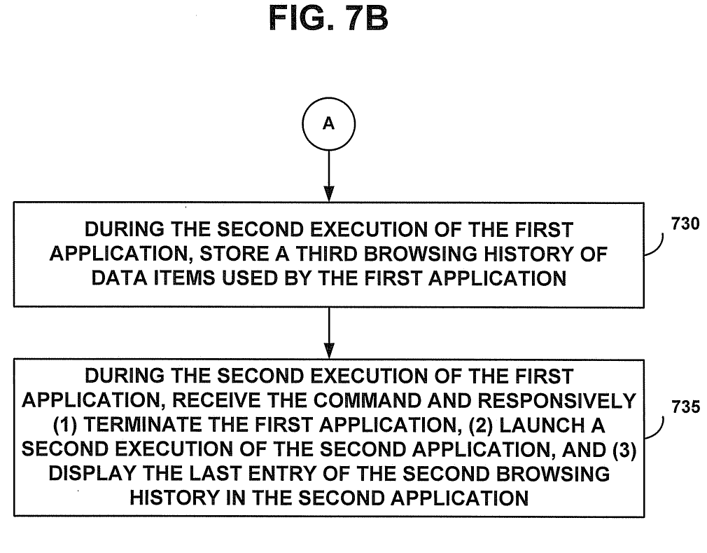

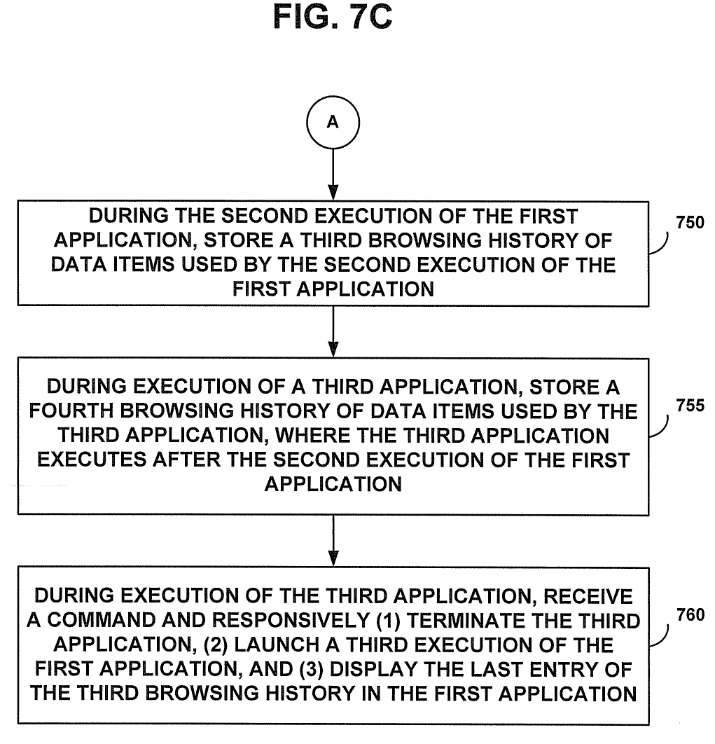

An alternate method 700 for storing and accessing application history is depicted in FIGS. 7A, 7B, and 7C. In FIG. 7A, at step 710, during a first execution of a first application, a first browsing history of data items used by the first application is stored. The first browsing history may comprise a last entry containing a most recently used data item of the first browsing history. At step 715, during execution of a second application, a second browsing history of data items used by the second application is stored. The second browsing history may comprise a first entry containing a least recently used data item. Preferably, the second application executes after the first execution of the first application.

At step 720, during execution of the second application, a command is received, and responsively (1) the second application is terminated, (2) a second execution of the first application is launched, and (3) the last entry of the first browsing history is displayed in the first application. Once the second execution of the first application is operating, a user, or some other entity, may seek to either return to the second application, or launch a third application.

FIG. 7B depicts returning to the second application. At step 730, during the second execution of the first application, a third browsing history of data items used by the second execution of the first application is stored. At step 735, during the second execution of the first application, a command is received and responsively (1) the first application is terminated, (2) a second execution of the second application is launched, and (3) the last entry of the second browsing history is displayed in the second application.

FIG. 7C depicts launching a third application. At step 750, during the second execution of the first application, a third browsing history of data items used by the second execution of the first application is stored. The third browsing history may comprise a last entry containing a most recently used data item of the first browsing history.

At step 755, during execution of a third application, a fourth browsing history of data items used by the third application is stored. The third application preferably executes after the second execution of the first application. At step 760, during execution of the third application, a command is received and responsively (1) the third application is terminated, (2) a third execution of the first application is launched, and (3) the last entry of the third browsing history is displayed in the first application.

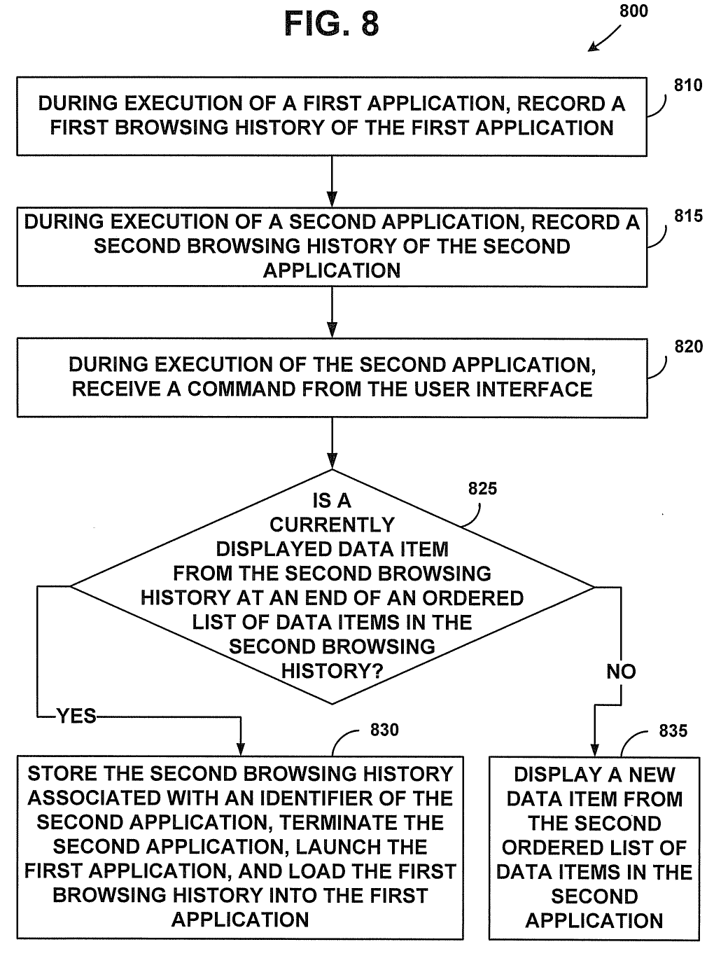

FIG. 8 depicts yet another method 800 for storing and accessing application history. At step 810, during execution of the first application, a first browsing history of the first application is recorded. The first browsing history may contain a first ordered list of data items used by the first instance of the first application. At step 815, during execution of a second application, a second browsing history of the second application is recorded. Similar to the first browsing history, the second browsing history may contain a second ordered list of data items used by the second application.

At step 820, during execution of the second application, a command is received from the user interface, and at step 825 a determination is made whether a currently displayed data item from the second browsing history is at an end of the second ordered list of data items in the second browsing history. The currently displayed data item may be considered at an end of the second ordered list of data items if it is the least-recently displayed or most-recently displayed data item.

In the case that the currently displayed data item is at the end of the second ordered list of data items in the second browsing history, then, at step 830, (1) the second browsing history is stored associated with an identifier of the second application, (2) the second application is terminated, (3) the first application is launched, and (4) the first browsing history is loaded into the first application. However, if the currently displayed data item is not at the end of the second ordered list of data items in the second browsing history, then, at step 835, a new data item from the second ordered list of data items is displayed in the second application. Preferably, the new data item is adjacent to the currently displayed data item in the second ordered list of data items. In other words, the new data item may be immediately before or after the currently displayed data item in the second browsing history.

In method 800, the command may be either a global back or a global forward command. For instance, assume that the command is a global back command. If the currently displayed data item from the second browsing history is an oldest data item from the second browsing history, then loading the first browsing history into the first application preferably comprises displaying a newest data item from the first ordered list. Otherwise, the next-oldest data item from the second ordered list is displayed.

On the other hand, assume that the command is a global forward command. If the currently displayed data item from the second browsing history is a newest data item from the second browsing history, then loading the first browsing history into the first application preferably comprises displaying an oldest data item from the first ordered list. Otherwise the next-newest data item from the second ordered list is displayed.

The methods depicted in FIGS. 6A, 6B, 6C, 6D, 7A, 7B, 7C, and 8 are not a complete representation of all methods that could operate in accordance with the preferred embodiments herein. Other methods may also be used. Furthermore, these methods may include more or fewer steps, and these steps may occur in a different order. Additionally, any of these methods may be combined with one another, in whole or in part.

The browsing histories recorded, stored, access, or otherwise manipulated by the methods depicted in FIGS. 6A, 6B, 6C, 6D, 7A, 7B, 7C, and 8 may be browsing histories associated with web browsing applications, email applications, location mapping applications, or other types of applications. Accordingly, the data items in these respective browsing histories may contain information such as URLs, cached copies of web pages, email messages, references to email messages, location coordinates, or other types of data.

Moreover, a browsing history may be available not only to later instances of the same application that recorded and stored the history, but to other applications as well. For example, a web browser may record and store a browsing history in the form of an ordered list of URLs. Then, a later instance of an email application may access this history so that a user can email one or more of the stored URLs to another party.

### V. Conclusion

Exemplary embodiments have been described above. Those skilled in the art will understand, however, that changes and modifications may be made to these embodiments without departing from the true scope and spirit of the invention, which is defined by the claims.

What is claimed is:

1. A communication device that supports at least a first application and a second application, the communication device comprising:
a processor;
a user interface capable of receiving commands from a user and displaying output from the first application and the second application to the user; and
a memory containing a first browsing history associated with a first instance of the first application and a second browsing history associated with a first instance of the second application, wherein execution of the first instance of the second application was initiated after execution of the first instance of the first application was initiated, the memory further containing program logic executable by the processor to: (1) during the execution of the first instance of the second application, receive input from the user interface, (2) responsively execute a second instance of the first application, and (3) load the first browsing history for use by the second instance of the first application.

2. The communication device of claim 1, wherein the input received from the user interface comprises a global back indication, thereby instructing the communication device to execute the second instance of the first application.

3. The communication device of claim 1, wherein the first application is a web browsing application, and the first browsing history contains a set of uniform resource locators (URLs) accessed during execution of the first instance of the first application, wherein the second instance of the first application can access the set of URLs.

4. The communication device of claim 3, wherein the first browsing history also contains, for each URL in the set, a cached copy of a web page associated with the URL, wherein the second instance of the first application can also access the cached copies of the web pages.

5. The communication device of claim 1, wherein the first application is a location mapping application, and wherein the first browsing history contains a set of map coordinates accessed during execution of the first instance of the first application, wherein the second instance of the first application can access the set of map coordinates.

6. The communication device of claim 1, wherein the first application is an email application, and wherein the first browsing history contains a set of email messages accessed during execution of the first instance of the first application, wherein the second instance of the first application can access the set of email messages.

7. The communication device of claim 1, further comprising:
the memory further containing program logic executable by the processor to, upon initiating execution of the first instance of the second application, store in the memory an identifier of the first application associated with the first browsing history, wherein the program logic executable to load the first browsing history for use by the second instance of the first application comprises program logic to use the identifier to access the first browsing history.

8. The communication device of claim 1, wherein the first browsing history contains an ordered list of data items, and wherein the program logic executable to load the first browsing history for use by the second instance of the first application comprises program logic executable to display, on the user interface, a most recently accessed data item of the ordered list.

9. A method, for use in a communication device that comprises a user interface and supports at least a first application and a second application, the method comprising:
during execution of a first instance of the first application, recording a first browsing history of the first application, wherein the first browsing history contains a first ordered list of data items used by the first instance of the first application;
during execution of the first instance of the first application, receiving a first launch command from the user interface to launch the second application;
responsive to receiving the first launch command: (1) storing the first browsing history, (2) terminating the first instance of the first application, and (3) launching the second application;
during execution of the second application, receiving a global back command from the user interface; and
responsively (1) launching a second instance of the first application, and (4) loading the first browsing history for use by the second instance of the first application such that a most recently used data item in the first browsing history is displayed in the second instance of the first application.

10. The method of claim 9, wherein the first application is a web browsing application, and wherein each data item of the ordered list in the first browsing history is associated with a uniform resource locator (URL) used by the first instance of the first application.

11. The method of claim 10, wherein each data item of the ordered list in the first browsing history is also associated with a cached copy of a web page associated with the URL that is associated with the data item.

12. The method of claim 9, wherein the first application is a location mapping application, and wherein each data item of the first ordered list in the first browsing history associated with map coordinates accessed during the first instance of the first application.

13. The method of claim 9, wherein the first application is an email application, and wherein each data item of the ordered list in the first browsing history associated with an email message used by the first instance of the first application.

14. The method of claim 9, further comprising:
during execution of the second application, recording a second browsing history of the second application, wherein the second browsing history contains a second ordered list of data items used by the second application;
responsive to receiving the global back command: (1) storing the second browsing history, (2) terminating the second application;
recording a third browsing history of the second instance of the first application during execution of the second instance of the first application, wherein the third browsing history contains an ordered list of data items used by the second instance of the first application;
during execution of the second instance of the first application, receiving a global forward command from the user interface; and
responsively, (1) launching a second instance of the second application, and (2) loading the second browsing history for use by the second instance of the second application.

15. The method of claim 9, wherein the communication device is also capable of supporting a third application, the method further comprising:
during execution of the second instance of the first application, recording a third browsing history of the second instance of the first application, wherein the third browsing history contains an ordered list of data items used by the second instance of the first application;
during execution of the second instance of the first application, receiving a second launch command from the user interface to launch the third application; and
responsive to receiving the second launch command: (1) storing the third browsing history, (2) terminating the second instance of the first application, and (3) launching the third application.

16. The method of claim 15, further comprising:
recording a fourth browsing history of the third application during execution of the third application, wherein the fourth browsing history contains an ordered list of data items used by the third application;
during execution of the third application, receiving the global back command from the user interface; and
responsively, (1) launching a third instance of the first application, (2) loading the third browsing history into the third instance of the first application such that the most recently used data item in the third browsing history is displayed in the third instance of the first application.

17. A method for switching between applications on a communication device, the method comprising:
during a first execution of a first application, storing a first browsing history of data items used by the first application, wherein the first browsing history comprises a last entry corresponding to a most recently used data item of the first browsing history;
during execution of a second application, storing a second browsing history of data items used by the second application, wherein the second browsing history comprises a first entry corresponding to a least recently used data item, and wherein the second application executes after the first execution of the first application; and
during execution of the second application, receiving a command and responsively (1) launching a second execution of the first application, and (2) displaying the last entry of the first browsing history in the first application.

18. The method of claim 17, wherein the second browsing history further comprises a last entry containing a most recently used data item of the second browsing history, the method further comprising:
during the second execution of the first application, storing a third browsing history of data items used by the second execution of the first application; and
during the second execution of the first application, receiving a command and responsively (1) launching a second execution of the second application, and (2) displaying the last entry of the second browsing history in the second application.

19. The method of claim 17, further comprising:
during the second execution of the first application, storing a third browsing history of data items used by the second execution of the first application, wherein the third browsing history comprises a last entry containing a most recently used data item of the third browsing history; and
during execution of a third application, receiving a command and responsively (1) launching a third execution of the first application, and (2) displaying the last entry of the third browsing history in the first application, wherein the third application executes after the second execution of the first application.

20. The method of claim 17, wherein the first application is a web browsing application, and wherein each data item of the ordered list in the first browsing history is associated with a uniform resource locator (URL) used by the first instance of the first application.

21. A method, for use in a communication device that contains a user interface and supports at least a first application and a second application, the method comprising:
during execution of the first application, recording a first browsing history of the first application, wherein the first browsing history contains a first ordered list of data items used by the first instance of the first application;
during execution of the second application, recording a second browsing history of the second application, wherein the second browsing history contains a second ordered list of data items used by the second application;
during execution of the second application, receiving a command from the user interface;
in response to receiving the command, determining whether a currently displayed data item from the second browsing history is at an end of the second ordered list of data items in the second browsing history;
if the currently displayed data item is at the end of the second ordered list of data items in the second browsing history, then: (1) launching the first application, and (2) loading the first browsing history into the first application; and
if the currently displayed data item is not at the end of the second ordered list of data items in the second browsing history, then displaying a new data item that is adjacent to the currently displayed data item in the second ordered list of data items.

22. The method of claim 21, wherein the command is a global back command, wherein the currently displayed data item from the second browsing history is an oldest data item from the second browsing history, and wherein loading the first browsing history into the first application comprises displaying a newest data item from the first ordered list.

23. The method of claim 21, wherein the command is a global back command, and wherein the new data item from the second ordered list is older than the currently displayed data item.

24. The method of claim 21, wherein the command is a global forward command, wherein the currently displayed data item from the second browsing history is a newest data item from the second browsing history, and wherein loading the first browsing history into the first application comprises displaying an oldest data item from the first ordered list.

25. The method of claim 21, wherein the command is a global forward command, and wherein the new data item from the second ordered list is newer than the currently displayed data item.
